(19) United States
(12) Patent Application Publication
(10) Pub. No.: US 2007/0013474 A1
(43) Pub. Date: Jan. 18, 2007

(54) Method for adjusting a sheet resistor, a sheet resistor, and an expansion measuring element

(76) Inventors: Philip Cutuli, Reutlingen (DE); Axel Jasenek, Stuttgart (DE); Ralf Geiger, Renningen (DE)

Correspondence Address: KENYON & KENYON LLP, ONE BROADWAY, NEW YORK, NY, 10004, US

(21) Appl. No.: 11/476,393

(22) Filed: Jun. 27, 2006

(30) Foreign Application Priority Data
Jun. 27, 2005 (DE) 10 2005 029 804.4

(51) Int. Cl. H01C 10/00

(52) U.S. Cl. 338/195

(57) ABSTRACT

A method for adjusting a sheet resistor, in particular in an expansion measuring element, is described, the sheet resistor having a low-resistance supply lead area and a high-resistance resistor area, which is electrically connected to the supply lead area, the method having the following steps: performing a first laser cutting step in the resistor area to modify the temperature coefficient of the offset voltage; performing a second laser cutting step to adjust the sheet resistor, so that an electric quantity of the sheet resistor and thereby the offset voltage is set as a function of a predefined setpoint value.

### FIELD OF THE INVENTION

The present invention relates to a method for adjusting a sheet resistor, in particular in a resistor bridge circuit of an expansion measuring element, as well as a sheet resistor and an expansion measuring element.

### BACKGROUND INFORMATION

Sheet resistors are often used in expansion measuring elements, for example, in high-pressure sensors. For this purpose, sheet resistors are usually applied to a deformable diaphragm in a star shape and connected to form a bridge circuit, a Wheatstone bridge in particular having four sheet resistors. When the diaphragm is exposed to pressure, the diaphragm bulges, whereby the individual sheet resistors expand or shrink, so that the offset voltage of the bridge circuit becomes detuned. Detuning of the bridge circuit results in a dependent electric signal, which is picked up by an analyzer circuit, which determines a measure of the pressure therefrom. Depending on the field of application, this requires high temperature stability, high sensitivity, and high long-time constancy over the entire service life of the expansion measuring element.

Sheet resistors for such a sensor are often made using the resistor material NiCr or NiCr Si, which is applied a suitable plating process as an amorphous layer having a resistor structure. The sheet resistors are contacted via a special contact layer or an appropriate layer system, such as NiCr/Pd/Au or Ni.

The resistance values of the sheet resistors of the bridge circuit are often not identical due to fluctuations which always occur in the structuring process for manufacturing the sheet resistors or other prior processes, so that the offset voltage of the bridge circuit is not equal to 0 V in the zero state of the expansion element, i.e., in the unstressed state. To adjust the value of the offset voltage to the specified value, the resistance values of one or maximum two selected sheet resistors of the bridge circuit are increased by adjustment. This is normally accomplished in an adjustment procedure in which the resistance value of the sheet resistor is increased in an adjustment area of the sheet resistor using a laser cutting step (melting of the resistor material with the help of a laser beam). The laser cutting procedure is customary for this purpose, because it makes high adjustment accuracy possible. The laser cutting procedure is based on removal of material by heating, so that the material of the sheet resistor is evaporated or melted and a separation line (cut line) is formed in the resistor material. At the edge of the cut line, a bead appears in the layer material, in which the previously amorphous material at least partially recrystallizes. The recrystallized area of the sheet resistor has, however, a different temperature coefficient of resistance compared to the amorphous area of the sheet resistor, so that the overall temperature response of the sheet resistor and of the bridge circuit is affected by the laser cutting procedure.

Since the laser cutting procedure for sheet resistors in a bridge circuit is normally performed so as to minimize the offset voltage of the bridge circuit, it results in a change in the temperature dependence of the offset voltage which is a function of the length of the laser cutting step but is impossible to determine in advance. The temperature dependence is determined in a final measuring procedure and, depending on whether the temperature coefficient of the offset voltage of the bridge circuit is within or outside the specified values, the sensor element is approved or discarded.

### SUMMARY OF THE INVENTION

The object of the present invention is to provide an improved method for adjusting a sheet resistor in which the yield is increased after the adjustment. In particular, it is the object of the present invention to provide a method for adjusting a bridge circuit having sheet resistors in which the resulting temperature coefficient of the offset voltage of the bridge circuit is minimized. It is furthermore the object of the present invention to provide a sheet resistor and an expansion measuring element which are adjustable in a simple manner, the effect of the adjustment process on the temperature dependence of the resistance being reduced.

This object is achieved via the method for adjusting a sheet resistor and by the sheet resistor and the expansion measuring element

According to a first aspect of the present invention, a method for adjusting a sheet resistor, in particular in an expansion measuring element, is provided. The sheet resistor has a low-resistance supply lead area and a high-resistance resistor area which is electrically connected to the supply lead area. In the method, a first laser cutting procedure is performed in the resistor area to modify the temperature coefficient of the sheet resistor. The resistance and thus the offset voltage is modified only slightly thereby. Subsequently, in a second laser cutting procedure, the sheet resistor is adjusted, so that the offset voltage of the sheet resistor is set as a function of a setpoint value.

The method according to the present invention makes it possible to compensate the effect of the laser cutting procedure on the temperature dependence of the resistance by initially performing a first laser cutting step in the resistor area of the sheet resistor in which a temperature coefficient of the resistance value of the sheet resistor is set in a predefined manner. This makes it possible to establish in advance the value or value range in which the temperature coefficient of resistance is located, making it possible to determine, mostly via the first laser cutting step, the range of the temperature coefficient of the offset voltage after the second laser cutting step

The first laser cutting step is preferably performed using a predefined first cut length in the resistor area of the sheet resistor. In particular, the cut may be performed along an edge section of the resistor area.

According to a preferred embodiment, the sheet resistor is provided in a bridge circuit, the first laser cutting step being performed to set the temperature coefficient of the sheet resistor resistance in such a way that a temperature coefficient of an offset value and/or of a total resistance of the bridge circuit is set at the predefined setpoint value. The first laser cutting step may then be preferably performed in such a way that the temperature coefficient of the offset voltage of the bridge circuit is essentially brought to 0 or close to 0.

According to another embodiment of the present invention, the second laser cutting step may be performed in the supply lead area of the sheet resistor using a second cut length, the second cut length being selected in such a way that the offset signal of the bridge circuit is set at the predefined setpoint value. The bridge circuit having the sheet resistor is thus adjusted in such a way that it meets a predefined specification.

The total resistance and/or the offset voltage of the bridge circuit may also be measured while performing the second laser cutting step along a cut line, the second laser cutting step being stopped when the offset voltage has reached the predefined value.

The second laser cutting step may preferably be performed in a supply lead area in such a way that a current-carrying cross section of the supply lead area is reduced in a segment, a conductive web being formed which is connected in series with the resistor area.

Furthermore, the supply lead area and/or the resistor area may have a plurality of connecting segments, the second laser cutting step being performed by cutting through the connecting segments consecutively by the second laser cutting step, the total resistance and/or the offset voltage of the bridge circuit being ascertained during the consecutive cuts through the connecting segments, and the cutting of the connecting segments being stopped when the total resistance and/or the offset voltage has reached or exceeded the predefined setpoint value.

According to a further aspect of the present invention, a sheet resistor is provided, in particular for an expansion measuring element for use in a bridge circuit. The sheet resistor has a low-resistance supply lead area and a high-resistance resistor area which is electrically connected to the supply lead area, the supply lead area and the resistor area being made of a conductive material. The supply lead area and/or the resistor area have a plurality of connecting segments between a first segment and a second segment of the supply lead area and the resistor area, which are arranged in such a way that each carries a portion of the current when current flows through the sheet resistor.

Such a sheet resistor has the advantage that it may be adjusted by cutting through the connecting segments in a defined way; the length of a bead area which affects the temperature coefficient in an undesirable manner may be reduced by cutting with the aid of a laser cutting procedure for adjustment.

According to another embodiment of the present invention, the connecting segments may be formed by web areas between the first and second segments which are separated from one another by one or more recesses in the layer material.

### BRIEF DESCRIPTION OF THE DRAWINGS

FIG. 1 shows an electrical circuit diagram of an interconnection of expansion-sensitive sheet resistors to form a bridge circuit in an electrical expansion measuring element.

FIG. 2 shows a detailed depiction of a sheet resistor for an expansion element according to FIG. 1.

FIGS. 3a and 3b show possible laser cutting steps into the supply lead areas of the sheet resistors for adjusting the expansion measuring element.

FIG. 4 shows a sheet resistor after a first laser cutting step into the resistor of the sheet resistor according to a preferred embodiment of the present invention.

FIG. 5 shows the temperature dependence of the offset voltages of a number of expansion measuring elements prior to the laser cutting step.

FIG. 6 shows the change in the temperature coefficients TKO of the offset voltage of the number of expansion measuring elements after the first laser cutting step into some of the expansion elements.

FIG. 7 shows the temperature dependence of the offset voltages of the number of expansion measuring elements after the second laser cutting step for adjusting the resistance values and/or the offset voltage of the expansion measuring element.

FIG. 8 shows another embodiment of a sheet resistor, in particular for an expansion measuring element, in which at least one supply lead area is provided with recesses.

FIG. 9 shows the temperature coefficients of the offset voltages according to the embodiment of FIG. 8 having a number of expansion measuring elements prior to the laser cutting step.

FIG. 10 shows the temperature coefficients of the offset voltages of a number of expansion measuring elements after the first laser cutting step in some of the expansion elements.

FIG. 11 shows the temperature coefficients of the offset voltage of a number of expansion measuring elements after the two laser cutting steps.

### DETAILED DESCRIPTION

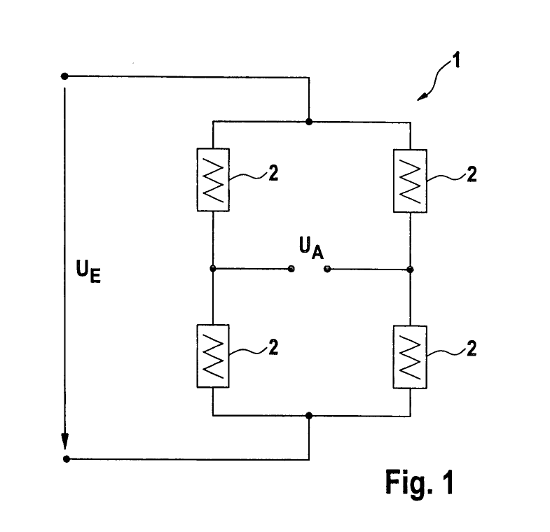

FIG. 1 shows an electrical circuit diagram of a bridge circuit I (Wheatstone bridge circuit) having expansion-sensitive sheet resistors 2, as used in expansion sensors, pressure sensors, and other sensor elements, for example. Sheet resistors 2 are often applied to a deformable sensor surface, which expands or shrinks according to the value to be measured. Sheet resistors 2 are arranged with their directions of highest sensitivity in a cross pattern. In bridge circuit 1, two sheet resistors 2 are connected in series and the current branches so formed are connected in parallel. Output voltage UA of such an expansion measuring element 1 may be picked up between a node between the two sheet resistors 2 of one current branch and a node between the two sheet resistors 2 of the second current branch.

Sheet resistors 2 are often designed to be of the same type, so that in the ideal case they have the same resistance. The ideal case would thus be the offset voltage in a zero state, i.e., with unstressed sheet resistors without expansion or shrinkage of the sensor surface on which sheet resistors 2 are applied, equal to 0 V when sheet resistors 2 have the same resistance. In practice, however, differences in the resistances of sheet resistors 2 occur due to the manufacturing method, so that the resistances of one or more of sheet resistors 2 must be adjusted using an adjustment procedure to output the minimum possible offset voltage in the unstressed state. Alternatively or additionally, bridge circuit 1 may also be adjusted in such a way that the total resistance, i.e., the input and output resistance of the bridge circuit, is in a range or has a predefined value predefined by a specification. Such an expansion measuring element 1 having different resistances also has a temperature dependence of its offset voltage and total resistance, which also should not exceed a certain value according to the specification.

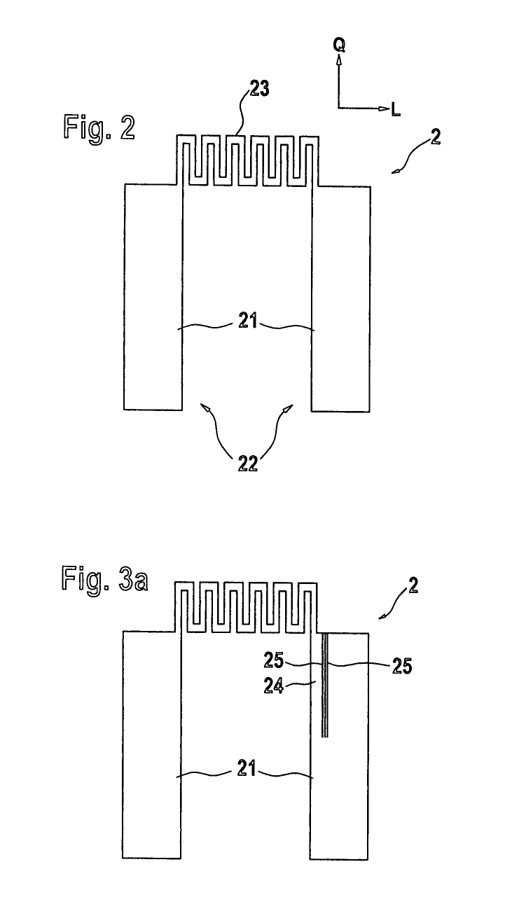

FIG. 2 shows a sheet resistor 2 in more detail. Sheet resistor 2 has two supply lead areas 21, which are electrically contactable from the outside via a suitable contact or are connected to another sheet resistor. Supply lead areas 21 are electrically connected to two terminals of a resistor area 23. Resistor area 23 has a meander-type structure, which reaches its maximum sensitivity to expansion and shrinkage in its transverse direction Q, and has a lower sensitivity to expansion and shrinkage in its longitudinal direction L. Sheet resistor 2 is applied selectively, in an integrated manner to a substrate (not shown), for example, a deformable sensor surface of a pressure sensor or the like, for example, with the aid of lithographic and masking methods, and thus has an essentially constant thickness. The material of the sheet resistor preferably has a NiCr—Si alloy, which is insulated against the sensor surface with the aid of an insulation layer, mostly of SiO₂. The material of the sheet resistor is normally applied in the amorphous form, for example, by sputtering.

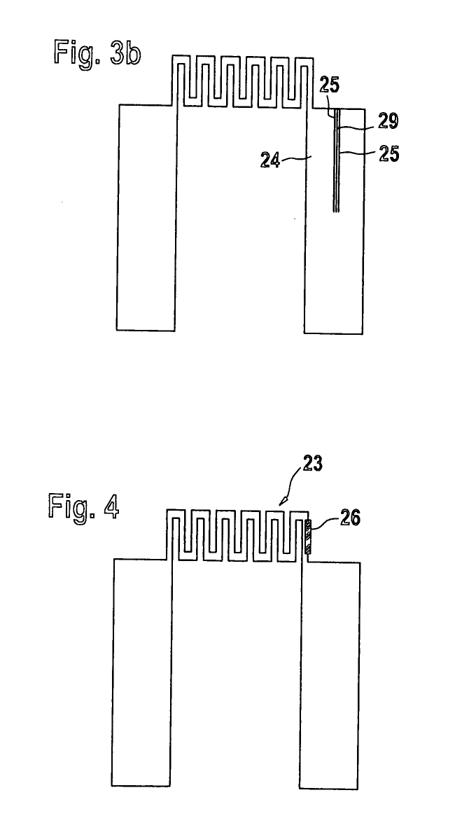

To adjust the offset voltage and/or the total resistance of bridge circuit 1, a cut is made into supply lead area 21 according to the related art and the resistance of the entire sheet resistor is thereby adjusted. The cut is preferably made with the aid of a laser cutting step, the resistor layer of sheet resistor 2 being melted with the aid of a laser and the resistor layer thus being cut through at the appropriate location. By melting the layer material, beads in which the amorphous resistor material recrystallizes upon solidifying are formed at the edges of both parts of the layer material along the cut line. The recrystallized layer material normally has a resistivity and a temperature coefficient of resistance which are different from those of the resistor material. Depending on the point at which the laser cutting step is made in the supply lead area, a web 24 of different width is formed which narrows the supply lead area for a predefined length and thus increases the total resistance of the sheet resistor. Examples for positions of the cut line in the supply lead area are shown in FIGS. 3a and 3b. The longer the laser cutting step in each individual sheet resistor, the greater is the effect of the different resistivity and the different temperature coefficient of resistance of the bead which is formed at the edge of the cut line. As a result, the temperature dependencies of the sheet resistors adjusted with the aid of the laser cutting step differ according to the lengths of the particular cut lines and thus may result in increased temperature dependence of the offset voltage and/or the total resistance of the bridge circuit. Since the length of the laser cutting step during adjustment of the offset voltage and/or the total resistance of the bridge circuit results, for example, from measuring the offset voltage and/or the total resistance during the adjustment process, i.e., while performing the laser cutting step, the temperature dependence cannot be set during the laser cutting step. For this reason, the laser cut is performed, according to the present invention, in two steps.

In a first laser cutting step, which is performed prior to the actual adjustment of the offset voltage and/or the total resistance, a first cut having a predefined length is made at the edge of the resistor area 23, so that part of the layer material of the resistor area is melted and recrystallizes in a bead. The cut is preferably made in such a way that the width of resistor area 23 and thus its resistance are not substantially reduced, and part of the layer material of resistor area 23 is transformed into a bead, which has a modified temperature coefficient of resistance. FIG. 4 shows a position of the first laser cut into the resistor area as an example. In this first laser cutting step (precut), the resistance of resistor area 23 is not substantially modified, but only its temperature coefficient, so that the first laser cutting step only affects the temperature coefficient of resistance of the sheet resistor, and the resistance of sheet resistor 2 is only slightly affected. This allows the temperature coefficient of sheet resistor 2, i.e., the offset voltage and/or the total resistance of the expansion measuring circuit in which sheet resistor 2 is used, to be adjusted as desired to the extent possible. The temperature dependence of the offset voltage and/or the total resistance of bridge circuit 1 is preferably brought into the range of zero in the first laser cutting step. In a subsequent second laser cutting step, the offset voltage and/or the total resistance of the bridge circuit is now set as known from the related art and in accordance with the predefined specifications.

The length of cut when cutting with the aid of the first laser cutting step (length of precut) is selected to be the same for a number of expansion measuring elements of a batch (having elements manufactured using the same manufacturing process), the mean temperature-dependence of the bridge circuits over the number of expansion measuring elements serving as a basis prior to performing the first laser cutting step. With the aid of empirical values or a computing model, one or more of the sheet resistors are selected as a function of the determined mean temperature dependence of the offset voltage and/or the total resistance and a first cut length is assigned to these sheet resistors. Subsequently the corresponding sheet resistors are cut with the aid of the first laser cutting step using the same first cut length (precut).

An essential aspect of the first laser cutting step is to achieve melting of the resistor material of the sheet resistor without substantially altering its total resistance. By melting and solidifying the resistor material in the resistor area, a bead of recrystallized resistor material is formed, which affects the temperature coefficient of the sheet resistor.

The web width resulting from the cut line when performing the second laser cutting step may be one-fourth to one-half of the original web width of the supply lead area. In other words, for a width of 200 μm of the supply lead area, the web width is between 50 μm and 100 μm.

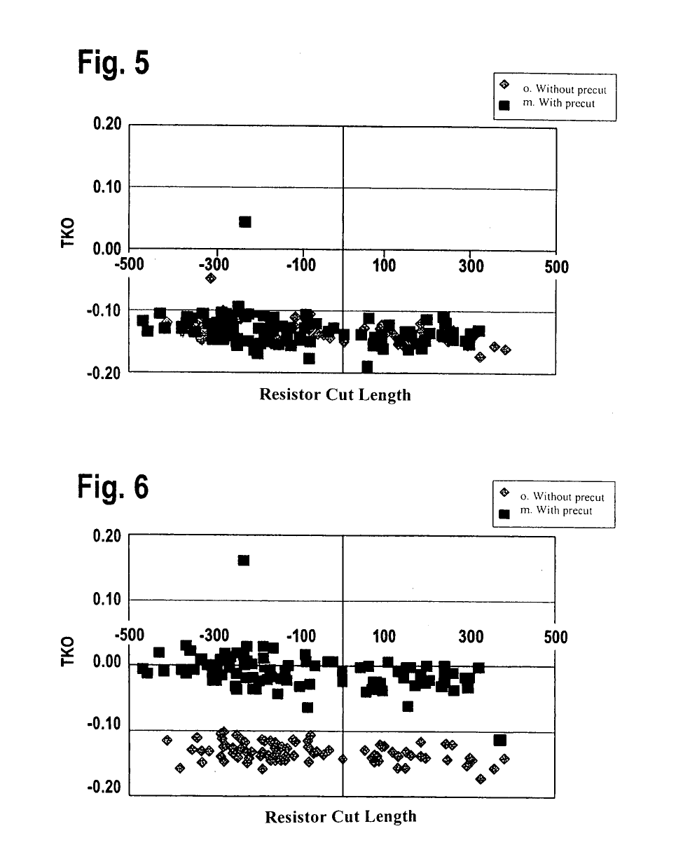

FIG. 5 shows the temperature coefficient of the offset voltage of a bridge circuit such as depicted in FIG. 1 for a number of expansion measuring elements. Two comparative groups of expansion measuring elements are formed, the measuring values represented by the squares corresponding to expansion measured values which are to be precut using the first laser cutting step in a subsequent step (using precut) and the measuring values provided with the help of a diamond corresponding to the expansion measuring elements which are to be adjusted without precut. FIG. 5 shows, not to scale, that the temperature dependence of the offset voltage is <0 for essentially all expansion measuring elements.

FIG. 6 depicts the modified temperature coefficient of the offset voltage after the first laser cutting step for both comparative groups of expansion measuring elements. It is apparent that, after the first laser cutting step, the adjusted expansion measuring elements (squares) have a temperature coefficient of the offset voltage which is in the range of approximately 0, i.e., the value of the temperature coefficient varies in a range around 0%/° K.

It is apparent that the first laser cutting step results in an essentially uniform shift of the temperature coefficient of the offset voltage without the scatter of the measuring values being increased. Consequently, with the aid of the first laser cutting step, the temperature coefficients of the offset voltage may be essentially equated to zero.

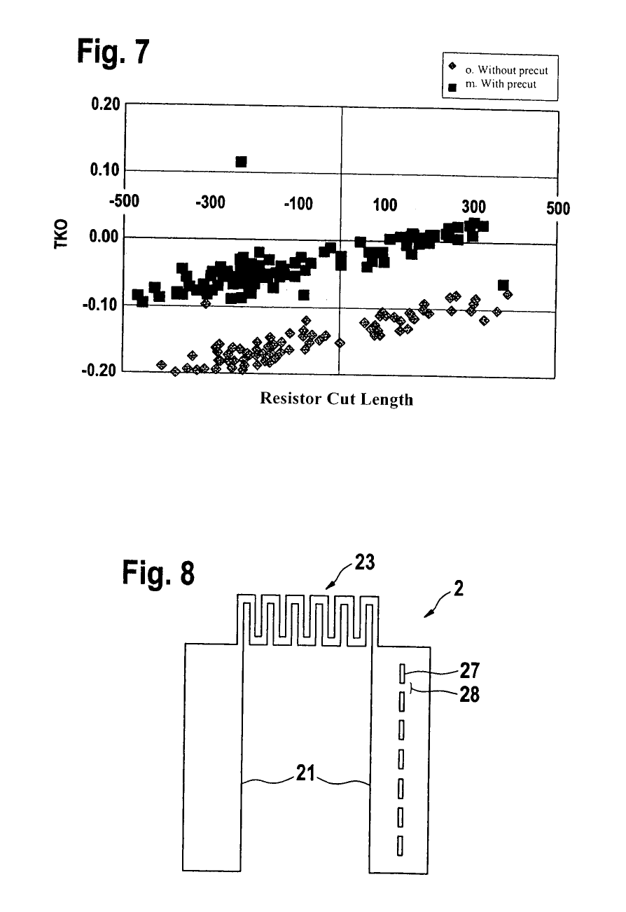

As FIG. 7 shows, each of the expansion measuring elements is now individually adjusted with the help of the second laser cutting step, so that a different shift in the temperature coefficient of the offset voltage results, depending on the cut length required. Since, according to the specification, the temperature coefficients of the offset voltage and/or the total resistance of the expansion measuring element should be within a tolerance range around 0, most of the expansion measuring elements may thus be better adjusted in such a way using the first laser cutting step that are within the specification. This is sometimes impossible in the case of expansion measuring elements which were not precut in the first laser cutting step, since, depending on the required cut length in the second laser cutting step, the temperature coefficient of the offset voltage and/or the total resistance is no longer in the range predefined by the specification. In this case the expansion measuring element must be discarded.

It is thus possible, using the method according to the present invention, to increase the yield in adjusting the sheet resistors, for example, for an expansion measuring element.

FIG. 8 shows an embodiment of a sheet resistor using which the effect of the cut length on the temperature coefficient of the offset voltage and/or of the total resistance may be reduced when cutting with the aid of the second laser cutting step. For this purpose, one of supply lead areas 21 is provided with recesses 27, which are provided as early as during the manufacture of sheet resistor 2 by the lithographic or masking method. Recesses 27 have no beads on their edges, which affects the temperature dependence in an undesirable manner, since they are not produced by a temperature process in which the resistor material of the sheet resistor is melted. Recesses 27 are arranged in a row in supply lead area 21, with connecting segments 28 located between the recesses. The row of recesses 27 runs essentially along the direction of a current flowing through the sheet resistor. When sheet resistor 2 is adjusted with the aid of the second laser cutting step, connecting segments 28 formed between recesses 27 are cut through consecutively; while cutting or after each cut through one of the webs, the offset voltage and/or the total resistance of bridge circuit 1 is measured. According to the measured value it is decided whether or not another connecting segment 28 is to be cut through. In particular when, after cutting through one of connecting segments 28, it is determined that the offset voltage and/or the total resistance has reached or exceeded the desired value, the second laser cutting step for the respective expansion measuring element is terminated.

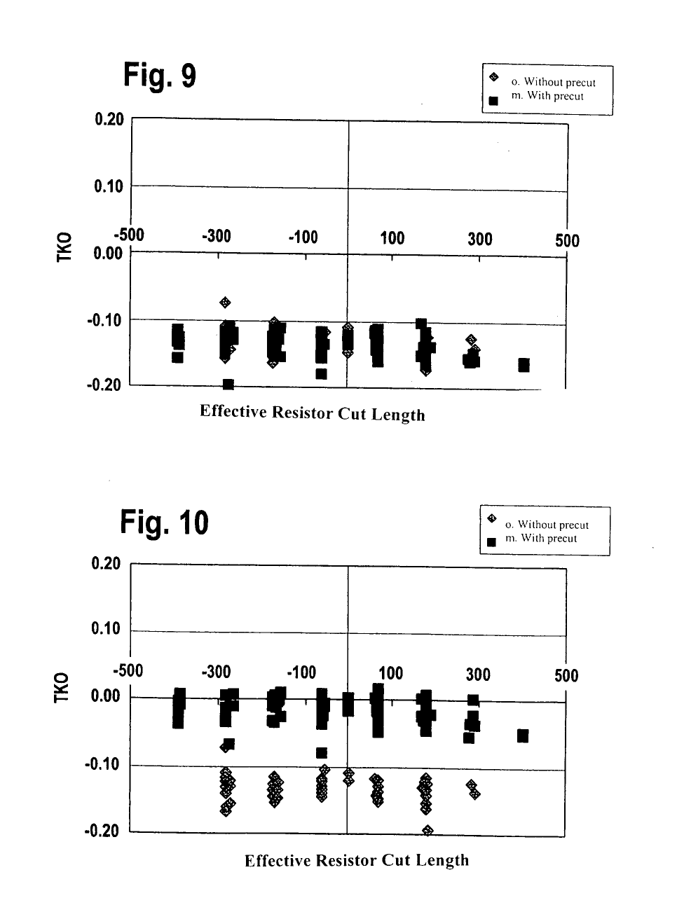

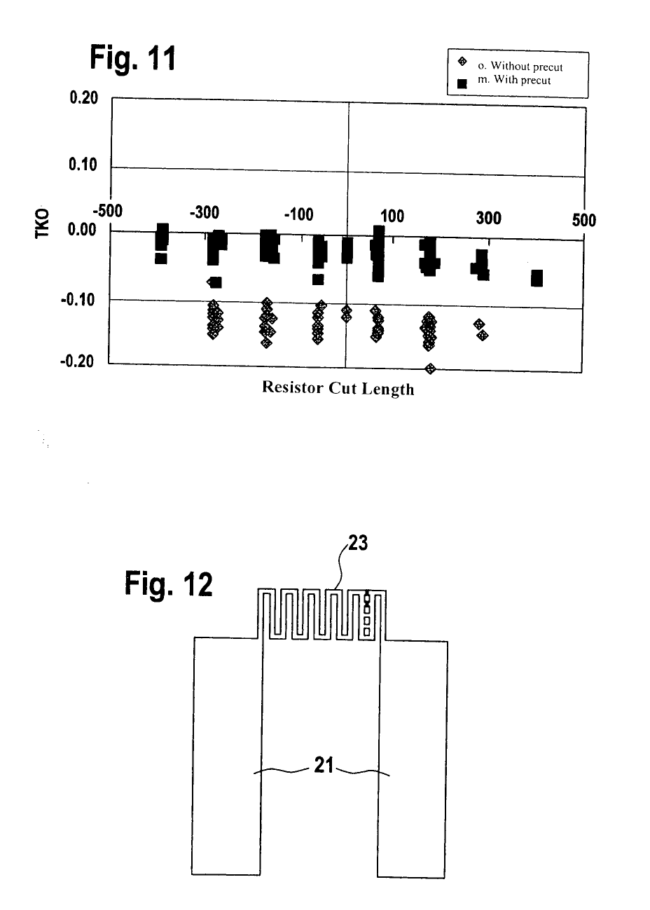

FIGS. 9 through 11, similarly to FIGS. 5 though 7, show the temperature coefficients of the offset voltages for a number of expansion measuring elements, each of which has a sheet resistor according to the embodiment of FIG. 8. It is apparent from FIG. 10 and from FIG. 6 that the temperature coefficients may be brought into a range around 0 using the first laser cutting step and the offset voltage and/or the total resistance of the expansion measuring element may be adjusted by performing the second laser cutting step according to FIG. 11. By providing connecting segments 28 and recesses 27 in supply lead area 21 of sheet resistor 2, the scattering of the temperature dependence of the offset voltage, resulting from the adaptation process during the second laser cutting step, becomes considerably smaller—in the example of the squares of FIG. 11, highly reduced compared to the diamonds of FIG. 7. This is caused by the fact that the areas in which a bead is formed from the recrystallized resistor material due to the second laser cutting step highly reduced compared to the examples of FIGS. 3a and 3b.

FIG. 12 shows a further embodiment of a sheet resistor according to the present invention. In meander-type resistor area 23, the sheet resistor has web-shaped connections between two meanders, which may be selectively cut through by the second laser cutting step to adapt the resistance of sheet resistor 2. The connections are cut through basically by the same method as described previously, while the offset voltage and/or the total resistance is/are being measured. Due to the quantized character of the adjustment in such a configuration of the sheet resistor, adjustment of the opposite resistor in the bridge circuit may be necessary.

### LIST OF REFERENCE NUMERALS

1 bridge circuit
2 sheet resistor
21 supply lead area
22 contact
23 resistor area
24 web
25 bead
26 cut area
27 recess
28 connecting segment
29 cut area

What is claimed is:

1. A method for adjusting a sheet resistor, the sheet resistor having a low-resistance supply lead area and a high-resistance resistor area that is electrically connected to the supply lead area, comprising:
performing a first laser cutting step in the resistor area to modify a temperature coefficient of an offset voltage;
performing a second laser cutting step; and
adjusting a resistance value of the sheet resistor as a function of a predefined setpoint value.

2. The method as recited in claim 1, wherein the first laser cutting step is performed using a predefined first cut length in the resistor area.

3. The method as recited in claim 2, wherein the first laser cutting step is performed by cutting along an edge area of the resistor area.

4. The method as recited in claim 1, further comprising:
providing the sheet resistor in a bridge circuit, wherein:
the first laser cutting step is performed to set a temperature coefficient of a sheet resistor resistance value in such a way that at least one of a temperature coefficient of an offset value and a total resistance of the bridge circuit is set at the predefined setpoint value.

5. The method as recited in claim 4, wherein:
the second laser cutting step is performed in the supply lead area of the sheet resistor using a second cut length, and
the second cut length is selected in such a way that at least one of the total resistance of the bridge circuit and the offset voltage of the bridge circuit is set at the predefined setpoint value.

6. The method as recited in claim 5, further comprising:
measuring at least one of the total resistance of the bridge circuit and the offset voltage of the bridge circuit while performing the second laser cutting step along a cut line; and
stopping the second laser cutting step when at least one of the total resistance and the offset voltage has reached the predefined setpoint value.

7. The method as recited in claim 5, wherein:
the second laser cutting step is performed in the supply lead area, so that a current-carrying cross section of the supply lead area is reduced in a segment, and
a conductive web is formed, the conductive web being connected in series with the resistor area.

8. The method as recited in claim 4, wherein:
at least one of the supply lead area and the resistor area includes a plurality of connecting segments,
the second laser cutting step is performed by cutting through the connecting segments consecutively,
at least one of the total resistance and the offset voltage of the bridge circuit is ascertained during the consecutive cuts through the connecting segments, and
the cut through the connecting segments is stopped when at least one of the total resistance and the offset voltage has one of reached and exceeded the predefined setpoint value.

9. The method as recited in claim 1, wherein the sheet resistor is for an expansion measuring element.

10. A sheet resistor, comprising:
a low-resistance supply lead area made of a conductive layer material; and
a high-resistance resistor area made of the conductive layer material and electrically connected to the supply lead area, wherein:
at least one of the supply lead area and the resistor area includes a plurality of connecting segments between a first segment and a second segment of the supply lead area and the resistor area, the first connecting segment and the second connecting segment being arranged in such a way that each carries a portion of a current when the current flows through the sheet resistor.

11. The sheet resistor as recited in claim 10, wherein:
the first connecting segment and the second connecting segment are formed via web areas between the first connecting segment and the second segments, the web areas being separated from one another by at least one recess in the conductive layer material.

12. An expansion measuring element, comprising:
a bridge circuit that includes at least one sheet resistor, the at least one sheet resistor including:
a low-resistance supply lead area made of a conductive layer material, and
a high-resistance resistor area made of the conductive layer material and electrically connected to the supply lead area, wherein:
at least one of the supply lead area and the resistor area includes a plurality of connecting segments between a first segment and a second segment of the supply lead area and the resistor area, the first connecting segment and the second connecting segment being arranged in such a way that each carries a portion of a current when the current flows through the sheet resistor.

13. The sheet resistor as recited in claim 10, wherein the sheet resistor is for an expansion measuring element for use in a bridge circuit.
